(19) United States
(12) Patent Application Publication
(10) Pub. No.: US 2022/0072711 A1
(43) Pub. Date: Mar. 10, 2022

(54) COORDINATION OF PATHS OF TWO ROBOT MANIPULATORS

(71) Applicant: FRANKA EMIKA GMBH, München (DE)

(72) Inventors: Daniel Wahrmann Lockhart, München (DE); Andreas Spenninger, Karlsfeld (DE); Mohamadreza Sabaghian, München (DE); Christoph Jähne, München (DE); Zheng Qu, Augsburg (DE); Thore Goll, München (DE); Benjamin Loinger, München (DE); Ahmed Wafik, München (DE); Christoph Kugler, München (DE); Carles Calafell Garcia, München (DE)

(21) Appl. No.: 17/424,738

(22) PCT Filed: Jan. 30, 2020
(86) PCT No.: PCT/EP2020/052275

§ 371 Date: Jul. 21, 2021

(30) Foreign Application Priority Data
Jan. 31, 2019 (DE) 10 2019 102 427.7

(51) Int. Cl. B25J 9/16; B25J 9/00; G05B 19/423

(52) U.S. Cl. CPC B25J 9/1682; B25J 9/0081; G05B 2219/40307; G05B 2219/39109; G05B 2219/39136; G05B 19/423

(57) ABSTRACT

System and method of learning and executing mutually coordinated paths of robot manipulators, including: manually guiding a first reference point of a first robot manipulator over a desired first path, acquiring the first path or acquiring a first set of poses for the first path and storing the first path or the first set of poses in a first data set, automatically traveling along the first path according to the first data set, while automatically traveling along the first path, manually guiding a second reference point of a second robot manipulator over a desired second path, acquiring the second path or acquiring a second set of poses for the second path and storing the second path or the second set of poses in a second data set, wherein the second data set is assigned to the first data set so that a location of the first path is at least approximately assigned to each location of the second path, and traveling along the first path by the first robot manipulator according to the first data set synchronized with traveling along the second path by the second robot manipulator according to the second data set.

The present application is the U.S. National Phase of PCT/EP2020/052275, filed on 30 Jan. 2020, which claims priority to German Patent Application No. 10 2019 102 427.7, filed on 31 Jan. 2019, the entire contents of which are incorporated herein by reference.

### BACKGROUND

### Field

The invention relates to a method for teaching and executing mutually coordinated paths of a first robot manipulator and a second robot manipulator, and a system to teach and execute mutually coordinated paths of a first robot manipulator and a second robot manipulator.

### Related Art

In particular, when a first robot manipulator and a second robot manipulator are supposed to perform a task cooperatively together, the question of the coordination of the first robot manipulator relative to the second robot manipulator arises. For example, if a load is to be lifted and transported by the first robot manipulator and the second robot manipulator together, it is crucial that the first and the second robot manipulator work together in a coordinated manner Also in other tasks that are to be carried out in a coordinated manner by a first and a second robot manipulator, their corresponding movement paths have to be precisely coordinated.

### SUMMARY

The object of the invention is to specify a movement path of a first robot manipulator and a second movement path of a second robot manipulator coordinated to the first movement path using a teaching process (also known as “teach-in”).

The invention results from the features of the independent claims. Advantageous refinements and embodiments are the subject matter of the dependent claims.

A first aspect of the invention relates to a method of teaching and executing mutually coordinated paths of robot manipulators, the method including:

manually guiding a first reference point of a first robot manipulator over a desired first path;

acquiring the desired first path or acquiring a first set of poses for the desired first path and storing the desired first path or the first set of poses in a first data set;

automatically traveling along the desired first path;

manually guiding a second reference point of a second robot manipulator over a desired second path, while automatically travelling along the desired first path;

acquiring the desired second path or acquiring a second set of poses for the desired second path and storing the desired second path or the second set of poses in a second data set, wherein the second data set is assigned to the first data set so that each location of the desired second path is at least approximately assigned to a location of the desired first path; and

traveling along the desired first path by the first robot manipulator according to the first data set synchronized with traveling along the desired second path by the second robot manipulator according to the second data set.

Manual guiding is preferably understood to mean a process in which the user places his hand, in particular, on one of the links of a respective robot manipulator and accelerates it in a desired direction by applying a force to it.

The first robot manipulator and the second robot manipulator are, in particular, two independent robot manipulators, i.e., each of the robot manipulators can perform tasks independently and is controlled by its own control unit. Alternatively, the first robot manipulator and the second robot manipulator are preferably arranged on a common platform and are controlled by a common control unit. The invention relates to both alternatives.

The term “set of poses” is advantageously understood to mean a time series of poses of the respective robot manipulator. Accordingly, a pose of the respective robot manipulator is acquired and stored, in particular, in each individual time step of a plurality of time steps. A pose is stored, in particular, as a vector of joint angles, so that a stored pose can be uniquely reproduced at any point in time. While in the first alternative a path of the respective reference point is explicitly acquired, for example, by an optical detection system, when a set of poses is acquired, in particular, a complete set of joint angles of the respective robot manipulator is thus acquired. If the set of poses is traveled along in accordance with the respective data set, the respective path of the respective reference point thus results automatically.

When assigning the second data set to the first data set, so that a location on the first path is at least approximately assigned to each location on the second path, it is not necessary for any location on the second path to be assigned to a location on the first path with complete mathematical correctness, but only approximately, so that the locations are also assignable to one another, for example, by interpolation of support points or other approximation methods.

In contrast to a trajectory, a respective path of a respective robot manipulator merely describes the geometric pathway of the respective reference point without containing an item of time information of a respective location on the pathway. In contrast, a trajectory contains the geometric pathway of the path, wherein each location is also assigned an item of time information as to the point in time at which the location is to be traversed.

The first path and also the second path are preferably acquired by position sensors, in particular, disposed on the joints of the respective robot manipulator.

For the manual guidance of a respective reference point, the guiding user can guide any links of the robot manipulator. It is not necessary for the user to start directly at the reference point of the respective robot manipulator.

The automatic traveling along the first path and the synchronized traveling along the first path and the second path each take place, in particular, by a corresponding control of actuators, using which the respective robot manipulator is movable.

In the case of the synchronized traveling, in particular, the first data set and the second data set are coordinated with one another in such a way that at a respective point in time, a location of the first path and a location of the second path have their respective relative position specified by the teaching process.

It is an advantageous effect of the invention that a first path of a first robot manipulator and a second path of a second robot manipulator are determinable in relation to one another very easily by a user. In particular, because the user only has to manually guide a single robot manipulator at a time, and in particular can observe the first robot manipulator while it is automatically traveling along the first path, a very precise teaching process is possible, in particular, of the second path of the second robot manipulator relative to the first path of the first robot manipulator.

According to an advantageous embodiment, the first data set stores the first path and the second data set stores the second path in each case as a discrete number of path points, wherein a length of the second data set is matched to the length of the first data set in order to assign the second data set to the first data set, so that the first data set and the second data set have an equal number of discrete path points.

Only when the first data set and the second data set have the equal number of discrete path points can the path points be assigned to one another directly. This is particularly advantageous in the case of discretely running control programs, according to which, in particular, the joint angles are regulated in discretized time steps. The matching of the respective lengths of the respective data set, which corresponds to the matching of the number of the respective discrete path points per data set, is preferably carried out by omitting a certain number of discrete stand points in the initially longer data set, or also by interpolation and generation of originally non-existent discrete path points in the initially shorter data set.

According to a further advantageous embodiment, the first data set stores the first path and the second data set stores the second path in a vectorized manner in each case.

In this context, vectorized means that the first path and the second path are in the form of an analytical expression, preferably by a polynomial function, Bézier curve, or another algebraic function that can be parameterized within its order. In this way, the first path and/or the second path are each advantageously stored in a very memory-efficient manner

According to a further advantageous embodiment, the first reference point is and/or the second reference point is a specified point on a respective end effector of the respective robot manipulator. The respective end effector of the respective robot manipulator is arranged, in particular, on the respective distal link of the respective robot manipulator.

According to a further advantageous embodiment, the first robot manipulator is controlled in a gravity-compensated manner while the first robot manipulator is being manually guided and/or the second robot manipulator is controlled in a gravity-compensated manner while the second robot manipulator is being manually guided.

In the case of gravity-compensated control, in particular, the actuators of a respective robot manipulator are controlled in such a way that gravity does not result in any acceleration of the respective robot manipulator. Apart from this control of the actuators, the respective robot manipulator can preferably be moved as required by manual guidance. This advantageously facilitates the manual guidance of the respective robot manipulator by a user.

According to a further advantageous embodiment, the first robot manipulator and/or the second robot manipulator each has links connected to one another by joints with degrees of freedom at least partially redundant to one another, so that at least a subset of the links of the first robot manipulator and/or of the second robot manipulator are each movable in a null space, wherein the first data set and/or the second data set has, in addition to the respective path of the respective reference point, items of information about a respective pose of the respective robot manipulator in its null space.

The pose of a respective robot manipulator generally describes both an orientation and a position of the entirety of the links of a respective robot manipulator or an end effector of a respective robot manipulator. Since a subset of the joints has degrees of freedom that are redundant to one another, some of the links of the respective robot manipulator, in particular, are movable in space without the position and/or the orientation of the end effector at the distal end of the respective robot manipulator or the position of the reference point changing at the same time. The movement of the links at the joints with redundant degrees of freedom is therefore also called movement in the null space. If this movement is understood as algebraic linear mapping, then the movement in the null space is also called the core of the mapping. The movement of these links via joints with redundant degrees of freedom takes place, in particular, without changing the position of the respective reference point at the same time.

Another aspect of the invention relates to a system to teach and execute mutually coordinated paths of robot manipulators, the system including: a first robot manipulator having a first path acquisition unit designed to acquire a desired first path of a first reference point of the first robot manipulator or a first set of poses for the desired first path during manual guidance of the first robot manipulator and store the desired first path or the first set of poses in a first data set; and a first control unit designed to control the first robot manipulator to travel along the desired first path according to the first data set; and a second robot manipulator having a second path acquisition unit designed to acquire a desired second path of a second reference point of the second robot manipulator or a second set of poses for the desired second path during manual guidance of the second robot manipulator while the first robot manipulator travels along the first path and store the desired second path or second set of poses in a second data set, wherein the second data set is assigned to the first data set in such a way that a location of the first path is at least approximately assigned to each location of the second path; and a second control unit designed to control the second robot manipulator to travel along the desired second path according to the second data set, wherein travel along the desired first path by the first robot manipulator according to the first data set is synchronized with travel along the desired second path by the second robot manipulator according to the second data set.

According to one advantageous embodiment, the first control unit and/or the second control unit are each designed to control the first robot manipulator to travel along the first path according to the first data set and, synchronized thereto, to control the second robot manipulator to travel along the second path according to the second data set.

Yet another aspect of the invention relates to a system to teach and execute mutually coordinated paths of robot manipulators, the system including: a first robot manipulator having a first path acquisition unit designed to acquire a desired first path of a first reference point of the first robot manipulator or a first set of poses for the desired first path during manual guidance of the first robot manipulator and store the desired first path or the first set of poses in a first data set; a second robot manipulator having a second path acquisition unit designed to acquire a desired second path of a second reference point of the second robot manipulator or a second set of poses for the desired second path during manual guidance of the second robot manipulator while the first robot manipulator travels along the first path and store the desired second path or second set of poses in a second data set, wherein the second data set is assigned to the first data set in such a way that a location of the first path is at least approximately assigned to each location of the second path; and a control unit designed to control the first robot manipulator to travel along the desired first path according to the first data set and to control the second robot manipulator to travel along the desired second path according to the second data set, wherein travel along the desired first path by the first robot manipulator according to the first data set is synchronized with travel along the desired second path by the second robot manipulator according to the second data set.

Advantages and preferred refinements of the proposed system result from an analogous and corresponding transfer of the statements made above in conjunction with the proposed method.

Further advantages, features, and details will be apparent from the following description, in which—possibly with reference to the drawing—at least one example embodiment is described in detail. Identical, similar, and/or functionally identical parts are provided with the same reference numerals.

### BRIEF DESCRIPTION OF THE DRAWINGS

In the drawings:

FIG. 1 shows a method of teaching and executing mutually coordinated paths of a first robot manipulator and a second manipulator robot according to one example embodiment of the invention, and

FIG. 2 shows a system to teach and execute mutually coordinated paths of a first robot manipulator and a second manipulator robot according to a further example embodiment of the invention.

The illustrations in the figures are schematic and not to scale.

### DETAILED DESCRIPTION

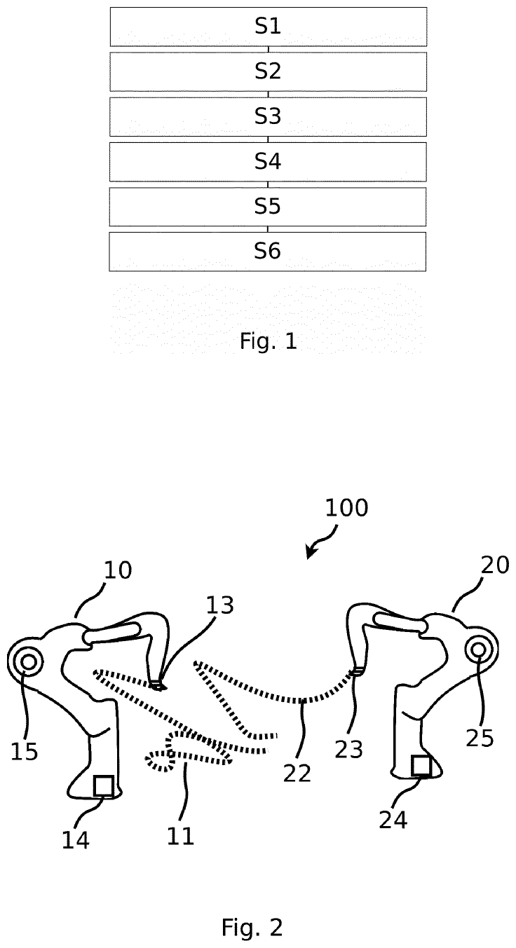

FIG. 1 shows a method of teaching and executing mutually coordinated paths 11, 22 of robot manipulators 10, 20, the method including:

manually guiding S1 a first reference point of a first robot manipulator 10 over a desired first path 11,

acquiring S2 the first path 11 and storing the first path 11 in a first data set,

automatically traveling S3 along the first path 11,

manually guiding S4 a second reference point of a second robot manipulator 20 over a desired second path 22, while automatically travelling along the first path 11,

acquiring S5 the second path 22 and storing the second path 22 in a second data set, wherein the second data set is assigned to the first data set such that a location of the first path 11 is at least approximately assigned to each location of the second path 22, and

traveling S6 along the first path 11 by the first robot manipulator 10 according to the first data set synchronized with traveling along the second path 22 by the second robot manipulator 20 according to the second data set.

FIG. 2 shows a system 100 to teach and execute mutually coordinated paths 11, 22 of robot manipulators 10, 20, the system including: a first robot manipulator 10 that includes a first path acquisition unit 15 designed to acquire a desired first path 11 of a first reference point of the first robot manipulator 10 during manual guidance of the first robot manipulator 10 and store the first reference point in a first data set, and a first control unit 14 designed to control the first robot manipulator 10 to travel along the first path 11 according to the first data set; and a second robot manipulator that includes a second path acquisition unit 25 designed to acquire a desired second path 22 of a second reference point of the second robot manipulator 20 during manual guidance of the second robot manipulator 20 while the first robot manipulator 10 travels along the first path 11 and store the second reference point in a second data set, wherein the second data set is assigned to the first data set in such a way that a location of the first path 11 is at least approximately assigned to each location of the second path 22; and a second control unit 24 designed to control the second robot manipulator 20 to travel along the desired second path 22 according to the second data set, wherein travel along the desired first path 11 by the first robot manipulator 10 according to the first data set is synchronized with travel along the desired second path 22 by the second robot manipulator 20 according to the second data set.

In an alternative embodiment of the system 100, instead of control units 14, 24, the first robot manipulator 10 and the second robot manipulator 20 are controlled by a common control unit. In this case, the common control unit is designed to control the first robot manipulator 10 to travel along the desired first path 11 according to the first data set and to control the second robot manipulator 20 to travel along the desired second path 22 according to the second data set, wherein travel along the desired first path 11 by the first robot manipulator 10 according to the first data set is synchronized with travel along the desired second path 22 by the second robot manipulator 20 according to the second data set.

Although the invention has been further illustrated and described in detail by way of preferred example embodiments, the invention is not limited by the disclosed examples, and other variations can be derived therefrom by a person skilled in the art without departing from the scope of the invention. It is therefore clear that a multitude of possible variations exists. It is also clear that embodiments mentioned as examples really only represent examples, which are not to be construed in any way as limiting the scope of protection, the possible applications, or the configuration of the invention. Rather, the preceding description and description of the figures enable a person skilled in the art to implement the example embodiments, wherein a person skilled in the art aware of the disclosed inventive concept may make various changes, for example as to the function or arrangement of individual elements cited in an example embodiment, without departing from the scope as defined by the claims and their legal equivalents, such as more extensive explanations in the description.

### LIST OF REFERENCE NUMERALS

10 first robot manipulator

11 first path

13 first end effector

14 first control unit

15 first path acquisition unit

20 second robot manipulator

22 second path

23 second end effector

24 second control unit

25 second path acquisition unit

100 system

S1 manual guidance

S2 acquisition

S3 automatic travel

S4 manual guidance

S5 acquisition

S6 synchronized travel

1. A method of learning and executing mutually coordinated paths of robot manipulators, the method comprising:
manually guiding a first reference point of a first robot manipulator over a desired first path;
acquiring the desired first path or acquiring a first set of poses for the desired first path and storing the desired first path or the first set of poses in a first data set;
automatically traveling along the desired first path according to the first data set;
manually guiding a second reference point of a second robot manipulator over a desired second path, while automatically traveling along the desired first path;
acquiring the desired second path or acquiring a second set of poses for the desired second path and storing the desired second path or the second set of poses in a second data set, wherein the second data set is assigned to the first data set so that a location of the desired first path is at least approximately assigned to each location of the desired second path; and
traveling along the desired first path by the first robot manipulator according to the first data set synchronized with traveling along the desired second path by the second robot manipulator according to the second data set.

2. The method according to claim 1, wherein the first data set stores the desired first path and the second data set stores the desired second path in each case using a discrete number of path points, and wherein the method comprises matching a length of the second data set to a length of the first data set in order to assign the second data set to the first data set, so that the first data set and the second data set have an equal number of discrete path points.

3. The method according to claim 1, wherein the first data set stores the desired first path and the second data set stores the desired second path in vectorized fashion, respectively.

4. The method according to claim 1, wherein the first reference point is a specified point on an end effector of the first robot manipulator, or the second reference point is a specified point on an end effector of the second robot manipulator, or the first reference point is a specified point on an end effector of the first robot manipulator and the second reference point is a specified point on an end effector of the second robot manipulator.

5. The method according to claim 1, further comprising controlling the first robot manipulator in a gravity-compensated manner during manual guidance of the first robot manipulator, or controlling the second robot manipulator in a gravity-compensated manner during manual guidance of the second robot manipulator, or controlling the first robot manipulator in a gravity-compensated manner during manual guidance of the first robot manipulator and controlling the second robot manipulator in a gravity-compensated manner during manual guidance of the second robot manipulator.

6. The method according to claim 1, wherein the first robot manipulator includes links connected by joints with degrees of freedom at least partially redundant to one another, so that at least a subset of the links of the first robot manipulator are each movable in a null space, and the first data set has, in addition to the desired first path of the first reference point, items of information about a pose of the first robot manipulator in its null space, or
wherein the second robot manipulator includes links connected by joints with degrees of freedom at least partially redundant to one another, so that at least a subset of the links of the second robot manipulator are each movable in a null space, and the second data set has, in addition to the desired second path of the second reference point, items of information about a pose of the second robot manipulator in its null space, or
wherein the first robot manipulator includes links connected by joints with degrees of freedom at least partially redundant to one another, so that at least a subset of the links of the first robot manipulator are each movable in a null space, and the first data set has, in addition to the desired first path of the first reference point, items of information about a pose of the first robot manipulator in its null space, and the second robot manipulator includes links connected by joints with degrees of freedom at least partially redundant to one another, so that at least a subset of the links of the second robot manipulator are each movable in a null space, and the second data set has, in addition to the desired second path of the second reference point, items of information about a pose of the second robot manipulator in its null space.

7. A system to teach and execute mutually coordinated paths of robot manipulators, the system comprising:
a first robot manipulator comprising: a first path acquisition unit is designed to acquire a desired first path of a first reference point of the first robot manipulator or a first set of poses for the desired first path during manual guidance of the first robot manipulator, and to store the first reference point or the first set of poses in a first data set; and a first control unit is designed to control the first robot manipulator to travel along the desired first path according to the first data set; and
a second robot manipulator comprising: a second path acquisition unit designed to acquire a desired second path of a second reference point of the second robot manipulator or a second set of poses for the desired second path during manual guidance of the second robot manipulator during travel along the desired first path by the first robot manipulator, and to store the second reference point or the second set of poses in a second data set, wherein the second data set is assigned to the first data set in such a way that a location of the first path is at least approximately assigned to each location of the second path; and a second control unit designed to control the second robot manipulator to travel along the desired second path according to the second data set, wherein travel along the desired first path by the first robot manipulator according to the first data set is synchronized with travel along the desired second path by the second robot manipulator according to the second data set.

8. The system according to claim 7, wherein the first control unit or the second control unit is designed to control the first robot manipulator to travel along the first path according to the first data set and, synchronized thereto, to control the second robot manipulator to travel along the second path according to the second data set, or each of the first control unit and the second control unit is designed to control the first robot manipulator to travel along the first path according to the first data set and, synchronized thereto, to control the second robot manipulator to travel along the second path according to the second data set.

9. The system according to claim 7, wherein the first data set stores the desired first path and the second data set stores the desired second path in each case using a discrete number of path points, and wherein a length of the second data set is matched to a length of the first data set in order to assign the second data set to the first data set, so that the first data set and the second data set have an equal number of discrete path points.

10. The system according to claim 7, wherein the first data set stores the desired first path and the second data set stores the desired second path in vectorized fashion, respectively.

11. The system according to claim 7, wherein the first reference point is a specified point on an end effector of the first robot manipulator, or the second reference point is a specified point on an end effector of the second robot manipulator, or the first reference point is a specified point on an end effector of the first robot manipulator and the second reference point is a specified point on an end effector of the second robot manipulator.

12. The system according to claim 7, wherein the first robot manipulator is controlled in a gravity-compensated manner during manual guidance of the first robot manipulator, the second robot manipulator is controlled in a gravity-compensated manner during manual guidance of the second robot manipulator, or the first robot manipulator is controlled in a gravity-compensated manner during manual guidance of the first robot manipulator and the second robot manipulator is controlled in a gravity-compensated manner during manual guidance of the second robot manipulator.

13. The system according to claim 7,
wherein the first robot manipulator includes links connected by joints with degrees of freedom at least partially redundant to one another, so that at least a subset of the links of the first robot manipulator are each movable in a null space, and the first data set has, in addition to the desired first path of the first reference point, items of information about a pose of the first robot manipulator in its null space, or
wherein the second robot manipulator includes links connected by joints with degrees of freedom at least partially redundant to one another, so that at least a subset of the links of the second robot manipulator are each movable in a null space, and the second data set has, in addition to the desired second path of the second reference point, items of information about a pose of the second robot manipulator in its null space, or
wherein the first robot manipulator includes links connected by joints with degrees of freedom at least partially redundant to one another, so that at least a subset of the links of the first robot manipulator are each movable in a null space, and the first data set has, in addition to the desired first path of the first reference point, items of information about a pose of the first robot manipulator in its null space, and the second robot manipulator includes links connected by joints with degrees of freedom at least partially redundant to one another, so that at least a subset of the links of the second robot manipulator are each movable in a null space, and the second data set has, in addition to the desired second path of the second reference point, items of information about a pose of the second robot manipulator in its null space.

14. A system to teach and execute mutually coordinated paths of robot manipulators, the system comprising:
a first robot manipulator comprising a first path acquisition unit designed to acquire a desired first path of a first reference point of the first robot manipulator or a first set of poses for the desired first path during manual guidance of the first robot manipulator, and to store the first reference point or the first set of poses in a first data set;
a second robot manipulator comprising a second path acquisition unit designed to acquire a desired second path of a second reference point of the second robot manipulator or a second set of poses for the desired second path during manual guidance of the second robot manipulator during travel along the desired first path by the first robot manipulator, and to store the second reference point or the second set of poses in a second data set, wherein the second data set is assigned to the first data set in such a way that a location of the first path is at least approximately assigned to each location of the second path; and
a control unit designed to control the first robot manipulator to travel along the desired first path according to the first data set and to control the second robot manipulator to travel along the desired second path according to the second data set, wherein travel along the desired first path by the first robot manipulator according to the first data set is synchronized with travel along the desired second path by the second robot manipulator according to the second data set.

15. The system according to claim 14, wherein the first data set stores the desired first path and the second data set stores the desired second path in each case using a discrete number of path points, and wherein a length of the second data set is matched to a length of the first data set in order to assign the second data set to the first data set, so that the first data set and the second data set have an equal number of discrete path points.

16. The system according to claim 14, wherein the first data set stores the desired first path and the second data set stores the desired second path in vectorized fashion, respectively.

17. The system according to claim 14, wherein the first reference point is a specified point on an end effector of the first robot manipulator, or the second reference point is a specified point on an end effector of the second robot manipulator, or the first reference point is a specified point on an end effector of the first robot manipulator and the second reference point is a specified point on an end effector of the second robot manipulator.

18. The system according to claim 14, wherein the first robot manipulator is controlled in a gravity-compensated manner during manual guidance of the first robot manipulator, the second robot manipulator is controlled in a gravity-compensated manner during manual guidance of the second robot manipulator, or the first robot manipulator is controlled in a gravity-compensated manner during manual guidance of the first robot manipulator and the second robot manipulator is controlled in a gravity-compensated manner during manual guidance of the second robot manipulator.

19. The system according to claim 14,
wherein the first robot manipulator includes links connected by joints with degrees of freedom at least partially redundant to one another, so that at least a subset of the links of the first robot manipulator are each movable in a null space, and the first data set has, in addition to the desired first path of the first reference point, items of information about a pose of the first robot manipulator in its null space, or
wherein the second robot manipulator includes links connected by joints with degrees of freedom at least partially redundant to one another, so that at least a subset of the links of the second robot manipulator are each movable in a null space, and the second data set has, in addition to the desired second path of the second reference point, items of information about a pose of the second robot manipulator in its null space, or
wherein the first robot manipulator includes links connected by joints with degrees of freedom at least partially redundant to one another, so that at least a subset of the links of the first robot manipulator are each movable in a null space, and the first data set has, in addition to the desired first path of the first reference point, items of information about a pose of the first robot manipulator in its null space, and the second robot manipulator includes links connected by joints with degrees of freedom at least partially redundant to one another, so that at least a subset of the links of the second robot manipulator are each movable in a null space, and the second data set has, in addition to the desired second path of the second reference point, items of information about a pose of the second robot manipulator in its null space.
